(19) United States
(12) Patent Application Publication
(10) Pub. No.: US 2014/0358646 A1
(43) Pub. Date: Dec. 4, 2014

(54) GAMIFICATION OF A NEW HIRE ONBOARDING PROCESS

(71) Applicants: Bare Said, St. Leon (DE); Robert Getzner, Heidelberg (AT)

(72) Inventors: Bare Said, St. Leon (DE); Robert Getzner, Heidelberg (AT)

(21) Appl. No.: 13/903,351

(22) Filed: May 28, 2013

(51) Int. Cl. G06Q 10/06

(52) U.S. Cl. CPC G06Q 10/06398
USPC 705/7.42

(57) ABSTRACT

The subject matter disclosed herein provides methods for monitoring the performance of activities by new and existing employees during the onboarding process using a virtual credit system. This method may maintain one or more new employee profiles and existing employee profiles. The new employee profile may include a new employee credit balance, and the existing employee profile may include an existing employee credit balance. The method may track one or more activities. Each activity may be associated with a credit value. Data indicating the performance of an activity by the new employee or existing employee may be received. At least one of the new employee profile or the existing employee profile may be updated based on the received data. The updating may adjust at least one of the new employee credit balance and the existing employee credit balance. Related apparatus, systems, techniques, and articles are also described.

### TECHNICAL FIELD

This disclosure relates generally to the monitoring of the performance of activities by new and existing employees during the onboarding process using a virtual credit system.

### BACKGROUND

Joining a company as a new employee presents many challenges. These challenges include, for example, developing an understanding of one's job responsibilities and quickly contributing to the company's successes. Many companies utilize onboarding programs (also referred to as new hire or new employee programs) to help new employees acquire the necessary knowledge and skills to become effective organizational members during the first few weeks or months of employment. Traditionally, these programs involve orientation activities and training sessions with the new employee's direct manager and team. Oftentimes, senior managers, subject matter experts, and employees of other departments may be left out of this process in an effort to focus the onboarding process. Whether these programs are successful can depend on the willingness of the new employee and his or her co-workers to participate in these activities.

### SUMMARY

In some implementations, methods and apparatus, including computer program products, are provided for monitoring of the performance of activities by new and existing employees during the onboarding process using a virtual credit system.

In one aspect, one or more profiles are maintained. Each of the one or more profiles are associated with a new employee or an existing employee. A new employee profile includes a new employee credit balance. An existing employee profile includes an existing employee credit balance. One or more activities are tracked. Each activity is associated with a credit value. Data indicating a performance of at least one activity by the new employee or the existing employee is received. At least one of the new employee profile and the existing employee profile are updated based on the received data. The updating includes adjusting at least one of the new employee credit balance and the existing employee credit balance.

The above methods, apparatus, and computer program products may, in some implementations, further include one or more of the following features.

The new employee profile may further include an onboarding level. The new employee profile may be initialized with an initial new employee credit balance and an initial onboarding level. The onboarding level may be increased when the new employee credit balance reaches one or more predetermined values or when the new employee performs a predetermined number of the one or more activities. The performance of a subset of the one or more activities may be prohibited until a threshold onboarding level is reached.

Credits may be assigned to the at least one activity performed by the new employee from the new employee credit balance. The assigned credits may be equal to the credit value associated with the at least one activity. The at least one activity performed by the new employee may be prioritized based on the assigning. The updating of the new employee profile may include changing the new employee credit balance by the credit value associated with the at least one activity performed by the new employee.

Credits from the new employee credit balance may not be assigned to the at least one activity performed by the new employee when the credit value associated with the at least one activity is greater than the new employee credit balance.

The at least one activity performed by the new employee may include at least one of sending a prioritized meeting request or a prioritized e-mail to the existing employee via a mail and groupware system, posting a prioritized question to a social media platform, creating a prioritized service ticket in a service ticket system, submitting an improvement idea to a feedback system, and completing a training class managed by a training system.

The at least one activity performed by the existing employee may include at least one of accepting the prioritized meeting request, responding to the prioritized e-mail, answering the prioritized question, and processing the prioritized service ticket.

The updating of the existing employee profile may include increasing the existing employee credit balance by the credits assigned to the prioritized activity by the new employee.

The data indicating the performance of the at least one activity by the new employee or the existing employee may be received from at least one of the mail and groupware system, the social media platform, the service ticket system, the feedback system, and the training system.

One or more key performance indicators associated with the one or more activities may be defined. Changes to at least one of the new employee credit balance and the existing employee credit may be monitored when the one or more activities associated with the one or more key performance indicators is performed by the new employee or the existing employee. A report may be generated based on the monitoring.

The one or more key performance indicators may include at least one of a total number of credits exchanged between one or more new employees and one or more existing employees during a predetermined period of time, a total number of credits assigned by the one or more new employees to the one or more activities during the predetermined period of time, and a total number of credits earned by the one or more existing employees during the predetermined period of time.

An alert may be generated if a value associated with the one or more key performance indicators decreases below a predetermined threshold.

The one or more profiles and the one or more activities may be stored in one or more databases.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF DRAWINGS

The accompanying drawings, which are incorporated herein and constitute a part of this specification, show certain aspects of the subject matter disclosed herein and, together with the description, help explain some of the principles associated with the subject matter disclosed herein. In the drawings,

FIG. 1 illustrates a system architecture for the gamification of the onboarding process, in accordance with some example implementations;

FIG. 2 illustrates activities performed by a new employee using various systems, in accordance with some example implementations;

FIG. 3 illustrates activities performed by an existing employee using various systems, in accordance with some example implementations; and

FIG. 4 illustrates a flowchart for updating either a new employee profile or an existing employee profile based on activities performed by the new employee or existing employee, in accordance with some example implementations.

Like reference symbols in the various drawings indicate like elements.

### DETAILED DESCRIPTION

Gamification techniques leverage people's natural desires for competition and achievement by applying game mechanics in a non-game context. Gamification techniques may be used to optimize the onboarding process by associating various onboarding activities with a virtual currency (for example, credits). A new employee may accumulate credits by accomplishing onboarding tasks and may exchange these credits with existing employees to schedule prioritized meetings, prioritized processing of service requests, and the like. Existing employees may, in turn, cash-in earned credits for various rewards including, for example, a financial bonus, additional vacation days, and the like. By monitoring the exchange of credits between new employees and existing employees, company officials (such as a human resources supervisor) may monitor the level of participation by employees in the onboarding process.

A new employee may be defined in terms of the duration of time that he or she has been at the company. This period of time may be set by company officials and may be measured by days, weeks, or months since the employee's first day with the company. If, for example, this period of time is set to two months, then an employee may be considered a new employee during his or her first two months at the company. After this period of time has passed (e.g., after the first two months), the new employee may be considered an existing employee.

In order to incentivize new employees and existing employees to participate in the onboarding process, credits may be given to these employees in exchange for performing various activities. These credits may, in turn, be redeemed for various rewards. Company officials may designate the types of activities that qualify for credits, the number of credits associated with each activity, the types of rewards that may be redeemed, and the number of credits required to redeem each reward. By designating the types of activities that qualify for credits and how these credits may be used, company officials may encourage activities deemed desirable to the onboarding process (e.g., by assigning high credit values to these activities) and discourage less desirable activities (e.g., by assigning zero or low credit values to these activities). In addition, this credit framework allows company officials to adjust the frequency at which credits are earned and spent (e.g., by assigning high credit values to a particular activity at the beginning of a quarter and low credit values to the same activity at the end of the quarter). This capability may be useful, for example, to encourage onboarding activities during periods of slow activity and to restrict these activities during busy periods (e.g., just before a product release).

In order to successfully complete the onboarding process, company officials may also require new employees to progress through a series of onboarding levels. Different activities and different training courses may be available to new employees as they progress through the various onboarding levels. A new employee may transition from one onboarding level to the next onboarding level based on the number of credits that he or she has accumulated. Company officials may set one or more predetermined credit thresholds to identify the number of credits needed to advance from one level to the next. For example, 50 credits may be required to advance from onboarding level 1 to onboarding level 2, while 200 credits may be required to advance from onboarding level 2 to onboarding level 3. Additionally or optionally, onboarding level advancement may be based on the new employee's training achievements. With regard to training, company officials may require new employees to successfully complete a certain number of courses in a certain number of subject areas before advancing to the next onboarding level.

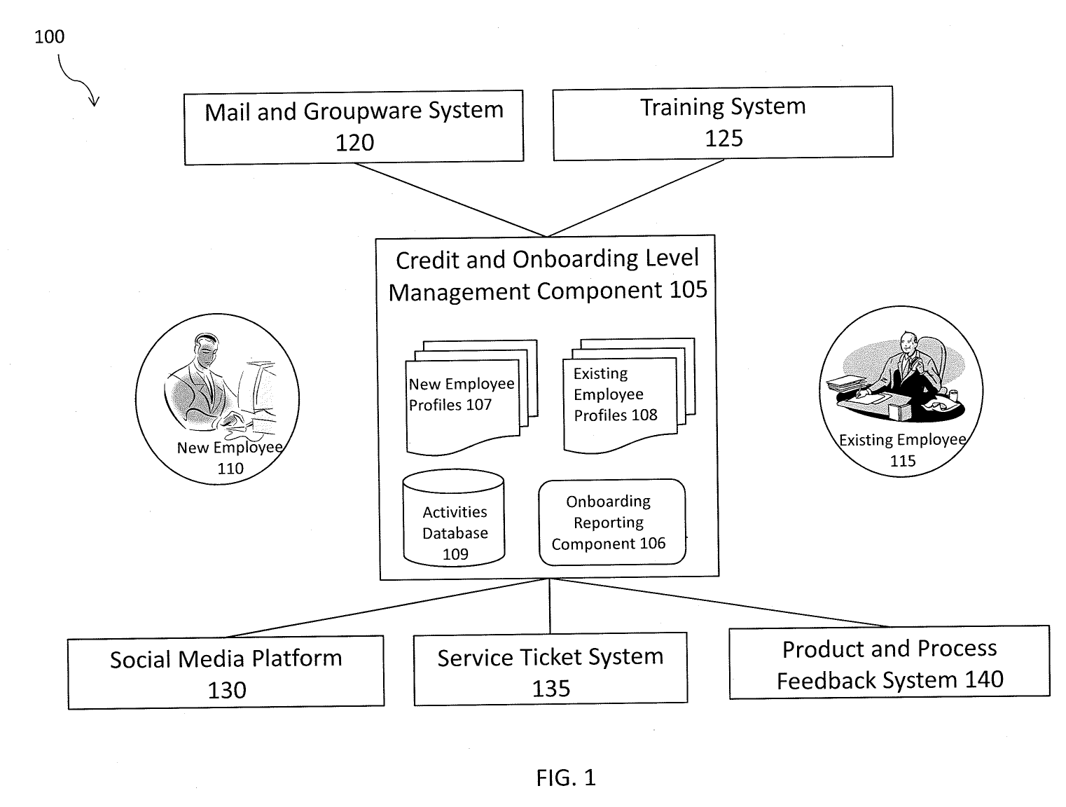

FIG. 1 illustrates a system architecture 100 that applies the gamification techniques described above to the onboarding process. Credit and onboarding level management component 105 may track each employee's credit balance and onboarding level (if applicable) using new employee profiles 107 and existing employee profiles 108. For example, a new employee profile 107 may track a new employee's credit balance and onboarding level, and an existing employee profile 108 may track an existing employee's credit balance. Although this disclosure refers separately to a new employee profile 107 and an existing employee profile 108, a unified employee profile may be used for both types of employees. In such an implementation, the unified employee profile may have a field that indicates whether the employee is a new employee (e.g., based on the length of time since his or her first day) or an existing employee. These profiles may be stored in a database at credit and onboarding level management component 105.

In addition to maintaining employee profiles, credit and onboarding level management component 105 may also maintain a database of activities 109. These activities may be performed by new and existing employees 110 and 115. Activities database 109 may specify the credit value associated with each of these activities as set by company officials. Activities database 109 may also indicate the number of credits and/or training requirements that must be satisfied in order to promote new employee 110 from one onboarding level to the next. In addition, activities database 109 may specify the initial credit balance allotted to new employee 110 and his or her initial onboarding level.

Credit and onboarding level management component 105 may be operatively connected to different systems in a company. These systems may include, for example, mail and groupware system 120, training system 125, social media platform 130, service ticket system 135, and product and process feedback system 140. As new employee 110 and/or existing employee 115 perform activities managed by these systems, these systems may report the performance of these activities back to credit and onboarding level management component 105. Reporting may occur in real-time following the performance of an event, on a periodic basis, or upon the occurrence of a predetermined trigger event. Upon receiving this reporting data, credit and onboarding level management component 105 may update new employee profile 107 and existing employee profile 108. This updating may include, for example, adjusting the credit balances for new employee 110 and experienced employee 115 and the onboarding level of the new employee based on the activities performed.

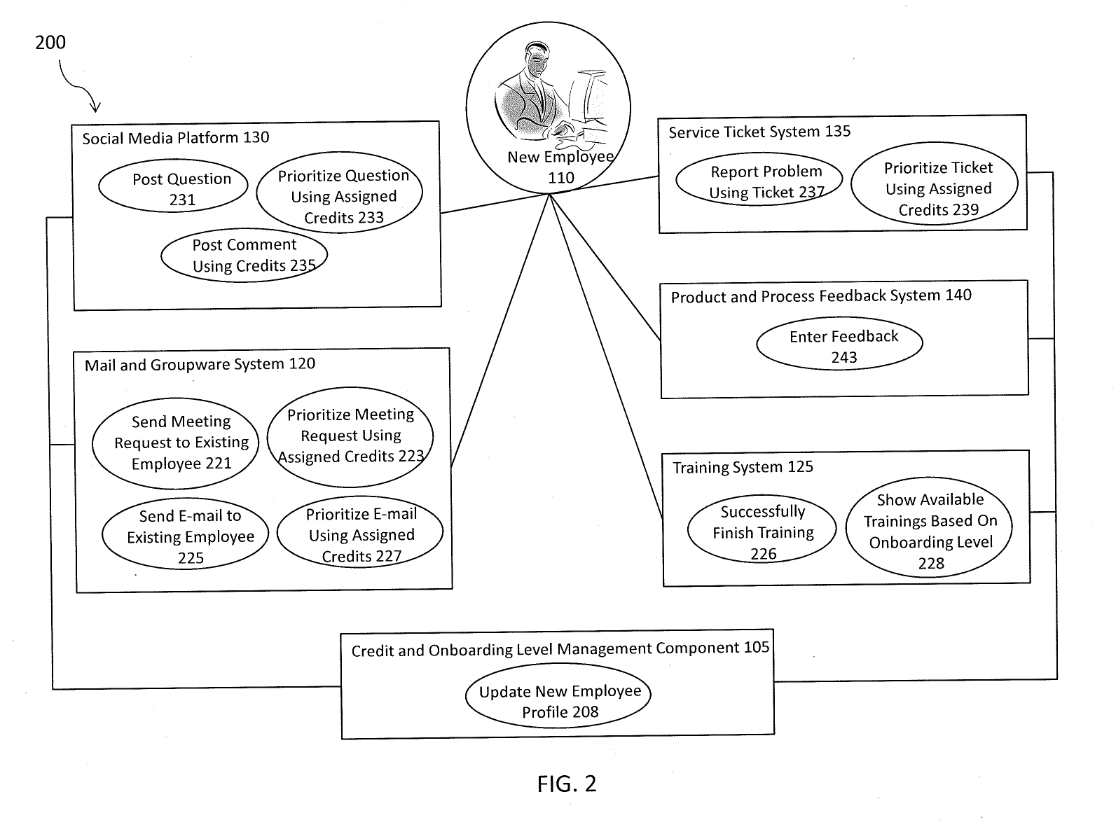

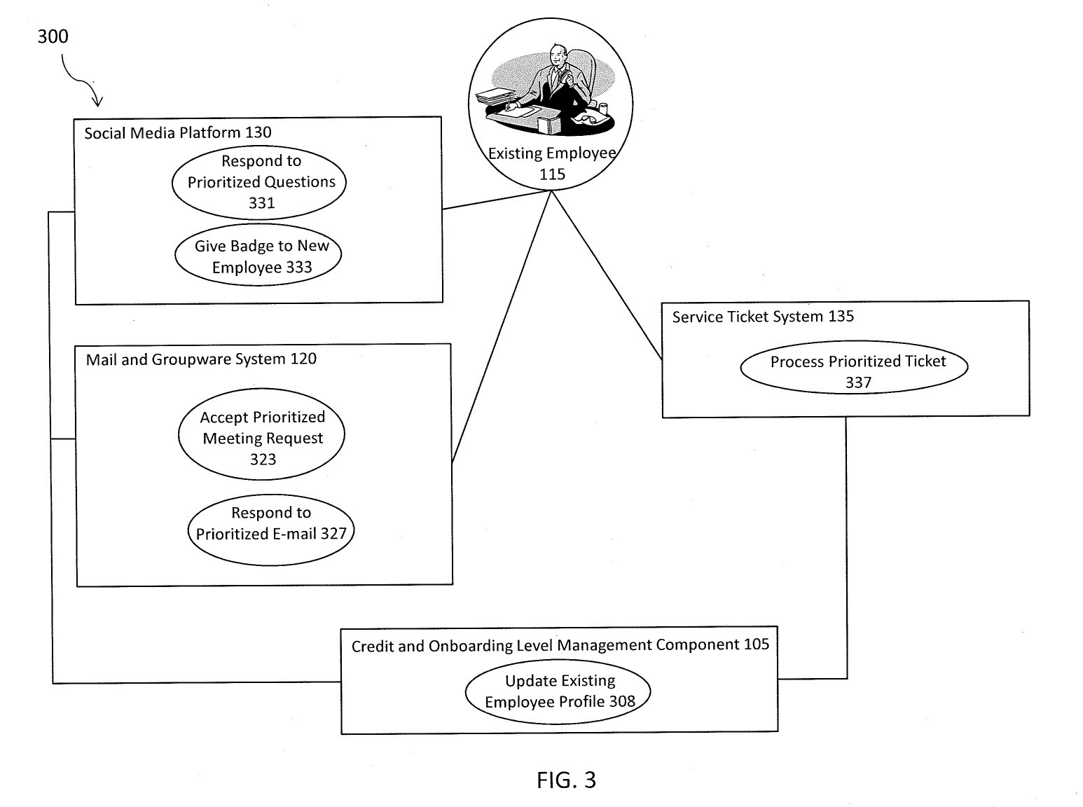

Each of the systems illustrated in FIG. 1 is described below with reference to FIGS. 2 and 3. FIG. 2 illustrates activities that may be performed by new employee 110 using mail and groupware system 120, training system 125, social media platform 130, service ticket system 135, and product and process feedback system 140. FIG. 3 illustrates activities that may be performed by existing employee 115 using mail and groupware system 120, social media platform 130, and service ticket system 135. FIGS. 2 and 3 also illustrate the interaction between these systems with credit and onboarding level management component 105.

New employee 110 may use mail and groupware system 120 to send meeting requests and e-mails to existing employees (processes 221 and 225). In order to encourage new employee 110 to contact existing employee 115, company officials may associate meeting requests and e-mails sent to an existing employee with a credit value as described above. The credit value associated with these activities may be stored in activities database 109.

New employee 110 may assign this credit value to the e-mail or meeting request. This may be done manually on an e-mail-by-e-mail basis or on a meeting request-by-meeting request basis. Alternatively, new employee 110 or company officials may create a rule that automatically assigns credits to all e-mails and all meeting requests destined for existing employee 115. In some implementations, credits may be assigned only to e-mails and meeting requests destined for a particular subset of existing employees (e.g., senior managers). Mail and groupware system 120 or credit and onboarding level management component 105 may check the new employee credit balance before assigning credits to the e-mail or meeting request. If new employee 110 has an insufficient credit balance (e.g., the new employee credit balance is lower than the credit value for the activity), then credits may not be assigned to the activity.

Once credits are assigned to the meeting request or e-mail, credit and onboarding level management component 105 may instruct mail and groupware system 120 to prioritize the meeting request or e-mail (processes 223 and 227). In addition, credit and onboarding level management component 105 may update new employee profile 107 by subtracting the credit value associated with this activity from the new employee credit balance (process 208). Once the prioritized meeting request and prioritized e-mail are sent, mail and groupware system 120 may send data to credit and onboarding level management component 105 to indicate performance of this activity.

A prioritized meeting request or e-mail may be displayed by mail and groupware system 120 with special formatting when the e-mail or meeting request is delivered to existing employee 115. For example, a prioritized meeting request or e-mail may be displayed in the recipient's inbox with colored text, highlighting, or a symbol to indicate that credits have been assigned to the incoming message. If existing employee 115 accepts the prioritized meeting request (process 323) or responds to the prioritized e-mail (process 327), then mail and groupware system 120 may send data to credit and onboarding level management component 105 to indicate the performance of the activity. Upon receiving this data, credit and onboarding level management component 105 may update the existing employee's profile 108 by adding the credit value for the performed activity to the existing employee credit balance (process 308).

In some implementations, company officials may prohibit or restrict the performance of certain activities by new employee 110 until certain threshold requirements are satisfied. For example, new employee 110 may not be allowed send a prioritized meeting request to a particular group of existing employees 115 (e.g., subject matter experts) until he or she has reached a particular onboarding level, obtained a particular number of credits, completed a particular number of training courses, and the like. These restrictions may prevent a new employee 110 from occupying a particular person's time unless the new employee has acquired certain credentials.

Credit and onboarding level management component 105 may save these prohibited activities and threshold requirements in database 109 and share this information with mail and groupware system 120. For example, mail and groupware system 120 may prohibit new employee 110 having an onboarding level of 1 from sending a meeting request to senior manager 115 until the new employee has been promoted to onboarding level 3. These prohibitions may also apply to other activities including, for example, the sending of e-mails to certain employees or any of the other activities described herein.

Training system 125 may administer and track training courses completed by new employees. Upon successful completion of a particular course by new employee 110 (process 226), training system 125 may transmit data indicating the same to credit and onboarding management level component 105. Upon receiving this information, credit and onboarding management level component 105 may determine whether credits are associated with the completion of this training course by consulting activities database 109. If so, credit and onboarding management level component 105 may update the new employee profile 107 by increasing the new employee credit balance by the credit value associated with the training course (process 208).

As described above, company officials may require new employees to complete certain training courses before advancing to the next onboarding level. Upon receiving data indicating the successful completion of a training course, credit and onboarding level management component 105 may consult the required training curriculum for each level to determine whether new employee 110 is eligible for advancement. If so, credit and onboarding level management component 105 may update new employee profile 107 by incrementing the onboarding level (process 208).

Different activities and training courses may become available to new employees as they advance from one onboarding level to the next. When credit and onboarding level management component 105 advances new employee 110 to the next onboarding level, the component may check the training curriculum to determine what new courses are available to the new employee. The credit and onboarding level management component 105 may communicate these newly available courses, if any, to training system 125 which, in turn, may send a message to new employee 110. This message may display the training courses available to new employee 110 based on his or her current onboarding level (process 228)

Social media platform 130 may be used by new and existing employees to create and share information in virtual communities and networks. Social media platform 130 may be implemented, for example, as an Internet based application. In order to encourage collaboration between new employees and existing employees, credits may be used by new employees to post questions to social media platform 130 (process 231). Company officials may associate the posting of a question to social media platform 130 with a particular credit value. This credit value may be stored in activities database 109 of credit and onboarding level management component 105.

A new employee 110 may assign credits to a posted question. Like the sending of e-mails and meeting requests described above, credits may be assigned either manually or automatically. Credits may be manually assigned by new employee 110 on a question-by-question basis. With regard to automatic credit assignment, new employee 110 or company officials may create a rule that automatically assigns credits to all questions posted to social media platform 130. In some implementations, credits may be assigned only to questions relating to specific topics or posted to specific discussion boards. Before credits may be assigned to a question, credit and onboarding level management component 105 or social media platform 130 (under the control of component 105) may check new employee profile 107 to determine whether new employee 110 has a sufficient new employee credit balance. If there are insufficient credits (i.e., the new employee credit balance is lower than the credit value for the activity), then credits may not be assigned.

Once credits are assigned to a question, credit and onboarding level management component 105 may instruct social media platform 130 to prioritize the question by displaying the question with special formatting (e.g., with colored text, highlighting, or a symbol) to indicate that credits have been assigned to the posted question (process 233). In addition, credit and onboarding level management component 105 may update the new employee's profile 107 by subtracting the credit value associated with the posted question from the new employee credit balance (process 208). Once the prioritized question is posted, social media platform 130 may send data to credit and onboarding level management component 105 indicating performance of the same.

Existing employee 115 may access social media platform 130 and respond to the prioritized question (process 331) in order to obtain the credits associated with this question. Social media platform 130 may send data to credit and onboarding level management component 105 to indicate the performance of this activity. Credit and onboarding level management component 105 may update existing employee profile 108 by adding the credit value for the question to existing employee's credit balance (process 308).

In addition to the posting and the answering of questions, other types of activities may be performed using social media platform 130. For example, new employee 110 may post comments to social media platform 130 using credits from his or her new employee credit balance (process 235). If existing employee 115 is particularly impressed with the comment or otherwise impressed by the performance of new employee 110, the existing employee may give a badge or commendation to the new employee using social media platform 130 (process 333). In order to encourage active participation in the onboarding process, social media platform 130 may publish the credit activity and onboarding level (if applicable) of existing and new employees for public viewing. Publication of this data may inform employees as to what others are doing and may allow company officials to identify the most active employees in the onboarding process. This published data may specify, for example, the credit balance for all existing and new employees or only a subset of those employees (e.g., a “top ten” list).

Service ticket system 135 may be used by new employees to report problems and request assistance from existing employees using service tickets (process 237). Company officials may associate the creation of a service ticket with a credit value. This credit value may be stored in database 109 of credit and onboarding level management component 105.

New employees may assign these credits to a service ticket. Credits may be assigned either manually (on a problem-by-problem basis) or automatically (using rules as described herein). Before credits are assigned, credit and onboarding level management component 105 or service ticket system 135 (under the control of component 105) may access new employee profile 107 to verify whether new employee 110 has a sufficient credit balance. If so, credits may be assigned, and credit and onboarding level management component 105 may update the new employee's profile 107 by subtracting the associated credit value from the new employee credit balance (process 208). Once credits are assigned to a service ticket, credit and onboarding level management component 105 may instruct service ticket system 135 to prioritize the service ticket (process 239). Once the service ticket is prioritized, service ticket system 135 may send data to credit and onboarding level management component 105 indicating performance of the same. Service ticket system 135 may display the prioritized service ticket with special formatting (e.g., with colored text, highlighting, or a symbol) to indicate that credits have been assigned to the service ticket.

If an existing employee 115 processes the prioritized service ticket (i.e., responds or provides assistance) (process 337), then service ticket system 135 may send data to credit and onboarding level management component 105 to indicate performance of this activity. Credit and onboarding level management component 105 may update the existing employee's profile 108 by adding the credit value for this particular activity to the existing employee credit balance (process 308).

Product and process feedback system 140 may be used by new employees to submit ideas for improving products produced by the company or processes implemented by the company. New employees who enter feedback into product and process feedback system 140 may be rewarded with credits. The credit value associated with this activity may be decided by company officials and saved to activities database 109 of credit and onboarding level management component 105. When new employee 110 submits an idea to process and product feedback system 140 (process 243), the process and product feedback system may send data to credit and onboarding level management component 105 reporting performance of the same. Upon receiving this data, credit and onboarding level management component 105 may update the new employee's profile 107 by adding the credit value associated with this activity to the new employee credit balance (process 208).

Referring again to FIG. 1, credit and onboarding level management component 105 may use onboarding reporting component 106 to monitor various key performance indicators associated with the onboarding process. These key performance indicators may be defined in onboarding level management component 105 and monitored to assess the level of participation by new and existing employees in onboarding activities.

In some implementations, the total number of credits exchanged between new employees and existing employees during a predetermined period of time may be monitored. As explained above, credits may be exchanged when a new employee assigns credits to an activity (e.g., prioritizes a meeting request), and the existing employee responds to the activity (e.g., accepts the prioritized meeting request). Credit and onboarding level management component 105 may monitor the number of exchanged credits by tracking variations in new and existing employee credit balances. This tracking may occur, for example, when credit and onboarding level management component 105 updates new and existing employee profiles 107 and 108 during processes 208 and 308, respectively.

When the total number of exchanged credits is large, new and existing employees may be actively exchanging credits. However, when this key performance indicator is small, participation levels may be low. This may occur, for example, when new employees assign credits to activities, but existing employees fail to respond. A low value may also appear if new employees are not performing activities associated with credits or are failing to assign credits to performed activities. The granularity of this data may be adjusted by limiting the monitoring process to a subset of new and existing employees (e.g., employees in a particular company department). In addition, this key performance indicator may be measured over various periods of time including, for example, a predetermined number of days, weeks, quarters, and the like.

Other key performance indicators that may be used include, for example, the total number of credits assigned by new employees during a predetermined period of time and the total number of credits earned by existing employees during a predetermined period of time. The above-identified indicators may be further classified by any of the activities described above. For example, with regard to the monitoring of credits assigned by new employees, onboarding reporting component 106 may be configured to only monitor those credits assigned to service requests in service ticket system 135 or questions posted to social media platform 130.

Onboarding reporting component 106 may generate reports based on the monitoring of the key performance indicators described above. These reports may include the value of the key performance indicator for the predetermined time period as well as a list of employees (new and/or existing) who performed activities within the ambit of the reported key performance indicator. In some implementations, these reports may also provide historical data for the key performance indicator. Company officials may use this historical data for comparison purposes.

In some implementations, each of the key performance indicators described above may be associated with a threshold value. This threshold value may be defined by company officials based on historical data. Onboarding reporting component 106 may be configured to generate an alert when the value of a key performance indicator decreases below the corresponding threshold value. In order to minimize the number of alerts resulting from temporary variations, onboarding reporting component 106 may be configured to generate alerts only when the value of the key performance indicator decreases below the threshold value for a given amount of time (e.g., 5 consecutive days). In some implementations, this alert may be generated when the value of the key performance indicator reaches a predetermined percentage of the threshold value. For example, onboarding reporting component 106 may generate an alert when the value of the key performance indicator is 70% of the threshold value.

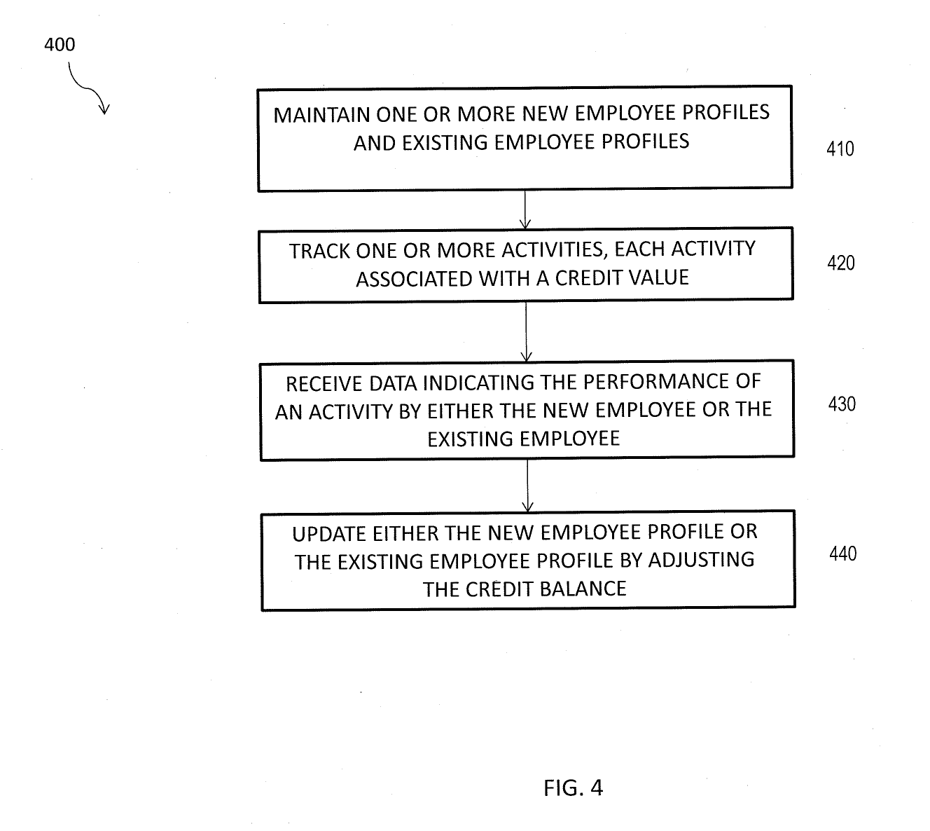

FIG. 4 illustrates a process 400 for updating either a new employee profile or an existing employee profile based on activities performed by new employee 110 or existing employee 115.

At 410, one or more new employee profiles and existing employee profiles may be maintained by credit and onboarding level management component 105. Each new employee profile 107 may have a new employee credit balance, and each existing employee profile 108 may have an existing employee credit balance. In some implementations, each new employee profile 107 may also have an onboarding level for new employee 110. In some implementations, the new employee profiles and existing employee profiles may be stored in a database.

At 420, one or more activities may be tracked by credit and onboarding level management component 105. Each of these activities may be associated with a credit value. As explained above with respect to FIGS. 1-3, these activities may involve the use of mail and groupware system 120, training system 125, social media platform 130, service ticket system 135, and product and process feedback system 140. For example, new employee 110 may send a meeting request to existing employee 115 via mail and groupware system 120. In some implementations, the one or more activities may be stored in a database.

At 430, credit and onboarding level management component 105 may receive data indicating the performance of an activity by either new employee 110 or existing employee 115. For example, if new employee 110 posts a question to social media platform 130 and assigns credits to the posted question, social media platform 130 may prioritize the posted question and send data to credit and onboarding level management component 105 to indicate the performance of this activity.

At 440, credit and onboarding level management component 105 may update new employee profile 107 and/or existing employee profile 108 by adjusting the new employee's credit balance, the existing employee's credit balance, or both. For example, if new employee 110 sends a meeting request to existing employee 115 and assigns credits to the meeting request, credit and onboarding level management component 105 may prioritize the meeting request and decrease the new employee credit balance by the credit value associated with the meeting request. If existing employee 115 accepts the prioritized meeting request, then credit and onboarding level management component 105 may increase the existing employee credit balance by the credit value associated with the meeting request.

One or more aspects or features of the subject matter described herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which may also be referred to as programs, software, software applications, applications, components, or code, include machine instructions for a programmable processor, and may be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results.

What is claimed is:

1. A non-transitory computer-readable medium containing instructions to configure a processor to perform operations comprising:
maintaining one or more profiles, each of the one or more profiles associated with a new employee or an existing employee, a new employee profile including a new employee credit balance, and an existing employee profile including an existing employee credit balance;
tracking one or more activities, each of the one or more activities associated with a credit value;
receiving data indicating a performance of at least one activity by the new employee or the existing employee; and
updating at least one of the new employee profile and the existing employee profile based on the received data, the updating including adjusting at least one of the new employee credit balance and the existing employee credit balance.

2. The non-transitory computer-readable medium of claim 1, wherein the new employee profile further comprises an onboarding level, and
wherein the new employee profile is initialized with an initial new employee credit balance and an initial onboarding level.

3. The non-transitory computer-readable medium of claim 2, wherein the onboarding level is increased when the new employee credit balance reaches one or more predetermined values or when the new employee performs a predetermined number of the one or more activities.

4. The non-transitory computer-readable medium of claim 2, the operations further comprising:
prohibiting the performance of a subset of the one or more activities until a threshold onboarding level is reached.

5. The non-transitory computer-readable medium of claim 1, the operations further comprising:
assigning credits to the at least one activity performed by the new employee from the new employee credit balance, the assigned credits equal to the credit value associated with the at least one activity; and
prioritizing the at least one activity performed by the new employee based on the assigning,
wherein the updating the new employee profile includes changing the new employee credit balance by the credit value associated with the at least one activity performed by the new employee.

6. The non-transitory computer-readable medium of claim 5, wherein credits from the new employee credit balance cannot be assigned to the at least one activity performed by the new employee when the credit value associated with the at least one activity is greater than the new employee credit balance.

7. The non-transitory computer-readable medium of claim 5, wherein the at least one activity performed by the new employee includes at least one of sending a prioritized meeting request or a prioritized e-mail to the existing employee via a mail and groupware system, posting a prioritized question to a social media platform, creating a prioritized service ticket in a service ticket system, submitting an improvement idea to a feedback system, and completing a training class managed by a training system.

8. The non-transitory computer-readable medium of claim 7, wherein the at least one activity performed by the existing employee includes at least one of accepting the prioritized meeting request, responding to the prioritized e-mail, answering the prioritized question, and processing the prioritized service ticket, and
wherein the updating of the existing employee profile includes increasing the existing employee credit balance by the credits assigned to the prioritized activity by the new employee.

9. The non-transitory computer-readable medium of claim 8, wherein the data indicating the performance of the at least one activity by the new employee or the existing employee is received from at least one of the mail and groupware system, the social media platform, the service ticket system, the feedback system, and the training system.

10. The non-transitory computer-readable medium of claim 1, the operations further comprising:
defining one or more key performance indicators associated with the one or more activities;
monitoring changes to at least one of the new employee credit balance and the existing employee credit when the one or more activities associated with the one or more key performance indicators is performed by the new employee or the existing employee; and
generating a report based on the monitoring.

11. The non-transitory computer-readable medium of claim 10, wherein the one or more key performance indicators include at least one of a total number of credits exchanged between one or more new employees and one or more existing employees during a predetermined period of time, a total number of credits assigned by the one or more new employees to the one or more activities during the predetermined period of time, and a total number of credits earned by the one or more existing employees during the predetermined period of time.

12. The non-transitory computer-readable medium of claim 10, the operations further comprising:
generating an alert if a value associated with the one or more key performance indicators decreases below a predetermined threshold.

13. The non-transitory computer-readable medium of claim 1, wherein the one or more profiles and the one or more activities are stored in one or more databases.

14. A method comprising:
maintaining one or more profiles, each of the one or more profiles associated with a new employee or an existing employee, a new employee profile including a new employee credit balance, and an existing employee profile including an existing employee credit balance;
tracking one or more activities, each of the one or more activities associated with a credit value;
receiving data indicating a performance of at least one activity by the new employee or the existing employee; and
updating at least one of the new employee profile and the existing employee profile based on the received data, the updating including adjusting at least one of the new employee credit balance and the existing employee credit balance.

15. The method of claim 14, wherein the new employee profile further comprises an onboarding level, and
wherein the new employee profile is initialized with an initial new employee credit balance and an initial onboarding level.

16. The method of claim 14 further comprising:
assigning credits to the at least one activity performed by the new employee from the new employee credit balance, the assigned credits equal to the credit value associated with the at least one activity; and
prioritizing the at least one activity performed by the new employee based on the assigning,
wherein the updating the new employee profile includes changing the new employee credit balance by the credit value associated with the at least one activity performed by the new employee.

17. The method of claim 14 further comprising:
defining one or more key performance indicators associated with the one or more activities;
monitoring changes to at least one of the new employee credit balance and the existing employee credit when the one or more activities associated with the one or more key performance indicators is performed by the new employee or the existing employee; and
generating a report based on the monitoring.

18. A system comprising:
a processor; and
a memory, wherein the processor and the memory are configured to perform operations comprising:
maintaining one or more profiles, each of the one or more profiles associated with a new employee or an existing employee, a new employee profile including a new employee credit balance, and an existing employee profile including an existing employee credit balance;
tracking one or more activities, each of the one or more activities associated with a credit value;
receiving data indicating a performance of at least one activity by the new employee or the existing employee; and
updating at least one of the new employee profile and the existing employee profile based on the received data, the updating including adjusting at least one of the new employee credit balance and the existing employee credit balance.

19. The system of claim 18, the operations further comprising:
assigning credits to the at least one activity performed by the new employee from the new employee credit balance, the assigned credits equal to the credit value associated with the at least one activity; and
prioritizing the at least one activity performed by the new employee based on the assigning,
wherein the updating the new employee profile includes changing the new employee credit balance by the credit value associated with the at least one activity performed by the new employee.

20. The system of claim 18, the operations further comprising:
defining one or more key performance indicators associated with the one or more activities;
monitoring changes to at least one of the new employee credit balance and the existing employee credit when the one or more activities associated with the one or more key performance indicators is performed by the new employee or the existing employee; and
generating a report based on the monitoring.
